(19) United States
(12) Patent Application Publication
(10) Pub. No.: US 2024/0241893 A1
(43) Pub. Date: Jul. 18, 2024

(54) SYSTEMS AND METHODS FOR PROVIDING ELECTRONIC MAPS

(71) Applicant: Argo AI, LLC, Pittsburgh, PA (US)

(72) Inventor: Michael Deasy, Pittsburgh, PA (US)

(21) Appl. No.: 18/154,283

(22) Filed: Jan. 13, 2023

(51) Int. Cl. G06F 16/29; G06F 16/22; G06F 16/25

(52) U.S. Cl. CPC G06F 16/29; G06F 16/2237; G06F 16/258

(57) ABSTRACT

Disclosed herein are systems, methods, and computer program products for providing an electronic map. The methods comprise: identifying at least one first data object that was changed during a last update of the electronic map; creating at least one geometry artifact by converting a format of data associated with the at least one first data object from a first data format to a different second data format (wherein the geometry artifact comprises 2D grid coordinates for a point, a line or a polygon); using the geometry artifact to generate first vector tile(s) in the different second data format; and selectively providing the first map in the first data format or the first vector tile(s) in the second data format based on characteristics of a software application or online service requesting access to contents of the electronic map.

### BACKGROUND

### Description of the Related Art

Autonomous Vehicles (AVs) have at least one on-board computer and have internet/satellite connectivity. The software running on these on-board computers monitor and/or control operations of the AVs. Operations of the AVs are controlled using High Definition (HD) maps. An HD map is a set of digital files containing data about physical details of a geographic area such as roads, lanes within roads, traffic signals and signs, barriers, and road surface markings. An AV uses HD map data to augment the information that the AV's on-board cameras, LiDAR system and/or other sensors perceive. The AV's on-board processing systems can quickly search map data to identify features of the AV's environment and/or to help verify information that the AV's sensors perceive.

Maps assume a static representation of the world. Because of this, over time, HD maps can become outdated. Map changes can occur due to new road construction, repaving and/or repainting of roads, road maintenance, construction projects that cause temporary lane changes and/or detours, or other reasons. In some geographic areas, HD maps can change several times per day, as fleets of vehicles gather new data and offload the data to map generation systems.

### SUMMARY

The present disclosure concerns implementing systems and methods for providing an electronic map. The methods comprise performing the following operations by computing device(s): identifying first data object(s) that was (were) changed during a last update of the electronic map; creating geometry artifact(s) by converting a format of data associated with the first data object(s) from a first data format (for example, a proprietary format) to a different second data format (for example, a standard geospatial format) (where the geometry artifact(s) comprise(s) 2D grid coordinates for point(s), line(s) or polygon(s)); using the geometry artifact(s) to generate first vector tile(s) in the different second data format; and selectively providing the first map in the first data format or the first vector tile(s) in the second data format based on characteristics of a software application or online service requesting access to contents of the electronic map. The characteristics can include, but are not limited to, a data format employed thereby and/or a data type processing capability thereof.

The methods described above may be embodied in a system including a processor and memory containing programming instructions that, when executed, will cause the processor to implement the actions described above. Various embodiments also include a computer program product that contains such programming instructions, and a memory containing the computer program product.

### BRIEF DESCRIPTION OF THE DRAWINGS

The accompanying drawings are incorporated into this document and form a part of the specification.

FIG. 1 provides an illustration of a system.

FIG. 2 provides an illustration showing point(s), line(s) and a polygon.

FIG. 3 provides a flow diagram of a method for continuously generating map geometry artifacts in a standard format.

FIG. 4 provides a flow diagram of a method for editing vector tiles in a standard format based on changes to a map in a proprietary format.

FIG. 5 provides a flow diagram of a method for on-the-fly vector tile generation.

FIG. 6 provides an illustration of a system.

FIG. 7 provides a more detailed illustration of an autonomous vehicle.

FIG. 8 provides a block diagram of an illustrative vehicle trajectory planning process.

FIG. 9 provides an illustration of a computer system.

In the drawings, like reference numbers generally indicate identical or similar elements. Additionally, generally, the left-most digit(s) of a reference number identifies the drawing in which the reference number first appears.

### DETAILED DESCRIPTION

As noted above, AVs have at least one on-board computer and have internet/satellite connectivity. The software running on these on-board computers monitor and/or control operations of the AVs. Operations of the AVs are controlled using HD maps. An AV uses HD map data to augment the information that the AV's on-board cameras, LiDAR system and/or other sensors perceive. The AV's on-board processing systems can quickly search map data to identify features of the AV's environment and/or to help verify information that the AV's sensors perceive.

The HD maps can be a proprietary format that is not compatible with some software applications and/or online services. Thus, this document describes system, apparatus, device, method and/or computer program product embodiments, and/or combinations and sub-combinations of any of the above, for transforming the proprietary format of the maps into a standard format so that the maps are accessible for different applications. The standardized format allows the maps to be used with different services in accordance with an agreed upon public data specification. This is especially useful when using open source and external tools. If the maps are only available in the proprietary format, then integration of the maps with other products would be difficult. The manner in which this transformation is achieved will become evident as the discussion progresses.

The present solution also concerns implementing systems and methods for providing an electronic map and/or controlling autonomous operations of a robot using the electronic map. The methods may comprise, for example: identifying first data object(s) that was (were) changed during a last update of the electronic map; creating geometry artifact(s) by converting a format of data associated with the first data object(s) from a first data format (for example, a proprietary format) to a different second data format (for example, a standard geospatial format); using the geometry artifact(s) to generate first vector tile(s) in the different second data format; storing the first vector tile(s) and/or the first vector tile(s) in a datastore; and/or selectively providing the first map in the first data format or the first vector tile(s) in the second data format based on characteristics of a software application or online service requesting access to contents of the electronic map.

In some scenarios, the methods may also comprise: receiving a request for any data objects of the electronic map that were changed within a particular period of time; initiating a search session in response to reception of the request; storing a start time of the search session in a datastore; and obtaining a last time that the electronic map was updated. The last time that the electronic map was updated may be used to identify the first data object(s). The search session may be completed after the geometry artifact(s) is(are) stored in the datastore.

In those or other scenarios, the methods involve receiving a request for a vector tile from the software application or online service. The first vector tile(s) is(are) generated on-the-fly using the geometry artifact(s) in response to the request. The first vector tile(s) may be part of a web-based map.

In those or other scenarios, the methods involve: identifying second vector tile(s) from a plurality of vector tiles that is(are) associated with second data object(s) of the electronic map which was (were) changed; decoding the second vector tile(s); generating first geospatial data by converting a format of the decoded second vector tile(s) into a geospatial format; generating second geospatial data by adding, removing or modifying a geographic feature of the first geospatial data; encoding the second geospatial data to generate modified vector tile(s); receiving a request for a vector tile from the software application or online service; and/or providing the modified vector tile(s) to the software application or online service in response to the request for a vector tile. The first vector tile(s), second vector tile(s) and/or modified vector tile(s) to control operations of a robot.

As used in this document, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” means “including, but not limited to.”

In this document, the term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” (or “AV”) is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle.

Definitions for additional terms that are relevant to this document are included at the end of this Detailed Description.

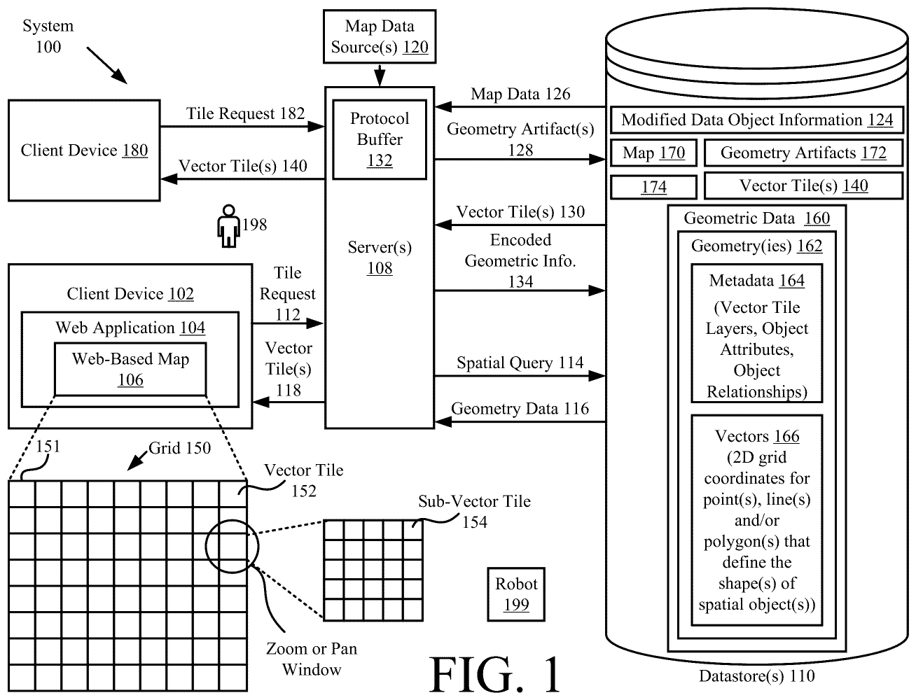

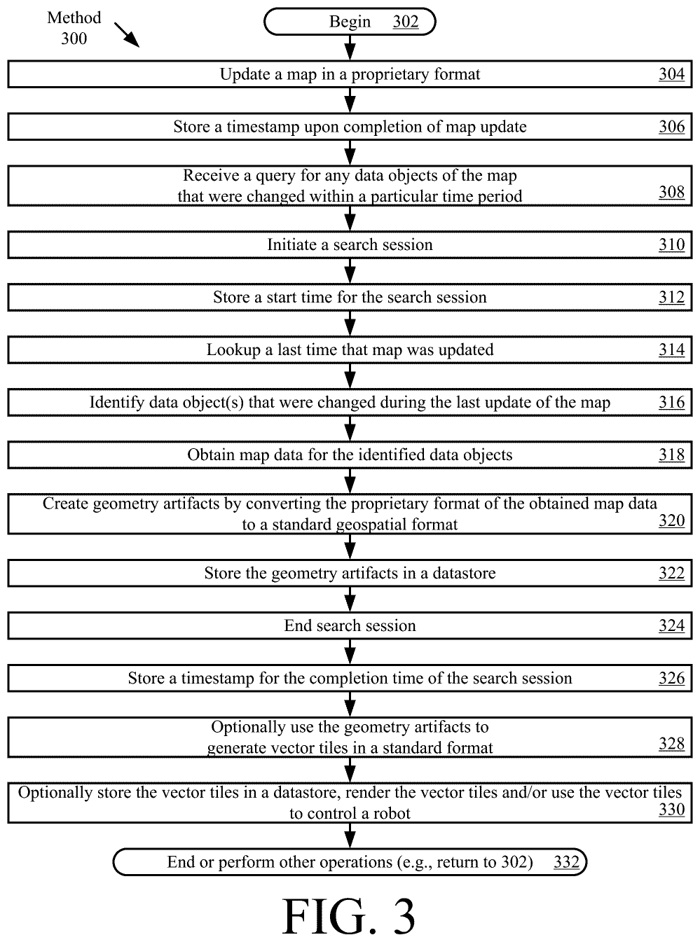

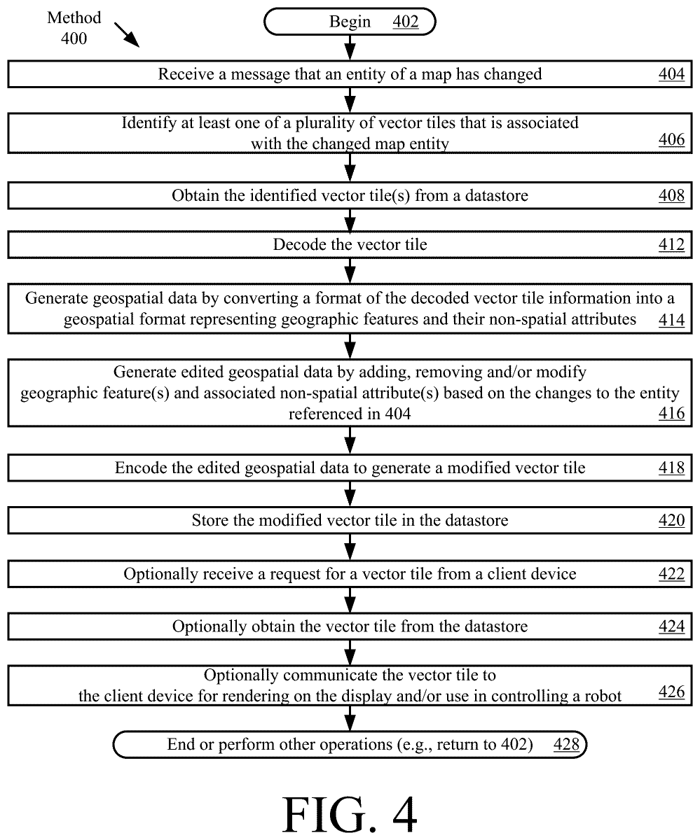

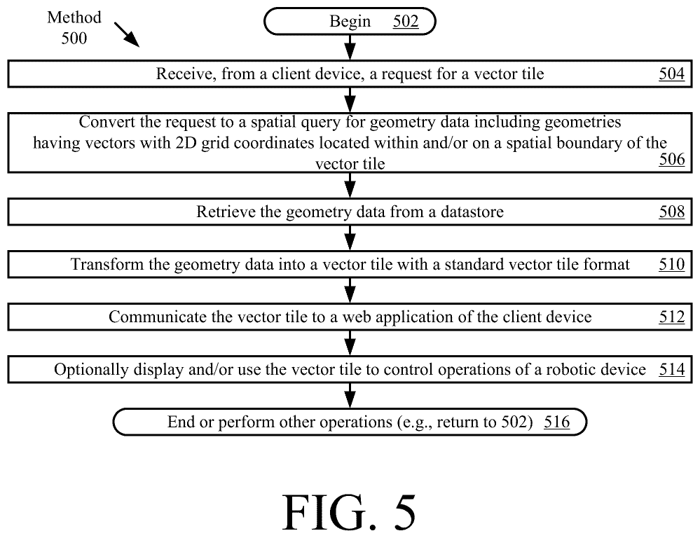

FIG. 1 provides an illustration of a system 100 implementing the present solution. System 100 is generally configured to (i) continuously generate geometry artifacts 172 and/or geometric data 160 in a standard format, (ii) edit vector tiles 140 in a standard format based on changes of a map 170 in a proprietary format, and (iii) perform on-the-fly vector tile generation. The process for function (i) is shown in the flow diagram of FIG. 3. The process for function (ii) is shown in the flow diagram of FIG. 4, and the process for function (iii) is shown in the flow diagram of FIG. 5. The process of FIGS. 3-5 can be combined into a single process in accordance with certain applications. The processes for these functions generally involve transforming the proprietary format of map 170 to a standard format. This transformation allows the map to be accessed by different software applications and plug-and-play with different services using an agreed upon public data specification. This is useful when open source and external tools are employed by system 100. The processes for functions (i)-(iii) will be discussed is more detail below in relation to FIGS. 3-5.

As shown in FIG. 1, a web-based map 106 may be rendered via a web application 104 being executed on a client device 102. The web application 104 can include, but is not limited to, a web browser and/or a navigation application. The web-based map 106 is made of vector tiles 152 arranged in a grid 150. Each vector tile 152 may comprise sub-vector tiles 154. Each vector tile 152, 154 represents a small piece of the overall map 170. The vector tiles 140 may be generated, for example, on a city-wide or sub-metro basis from collections of encoded features. The vector tiles can be generated using, for example, a known Tippecanoe tool configured to output tiles in a standard vector tile format. These tiles are referred to in the field as a mapbox vector tiles. These encoded features are referred to herein as geometric data 160 and geometric artifacts 172. The geometric data 160 and/or geometric artifacts 172 can, include, but are not limited to, GeoBuf encoded geographic data. GeoBuf is a known compact binary geospatial format for lossless compression of data.

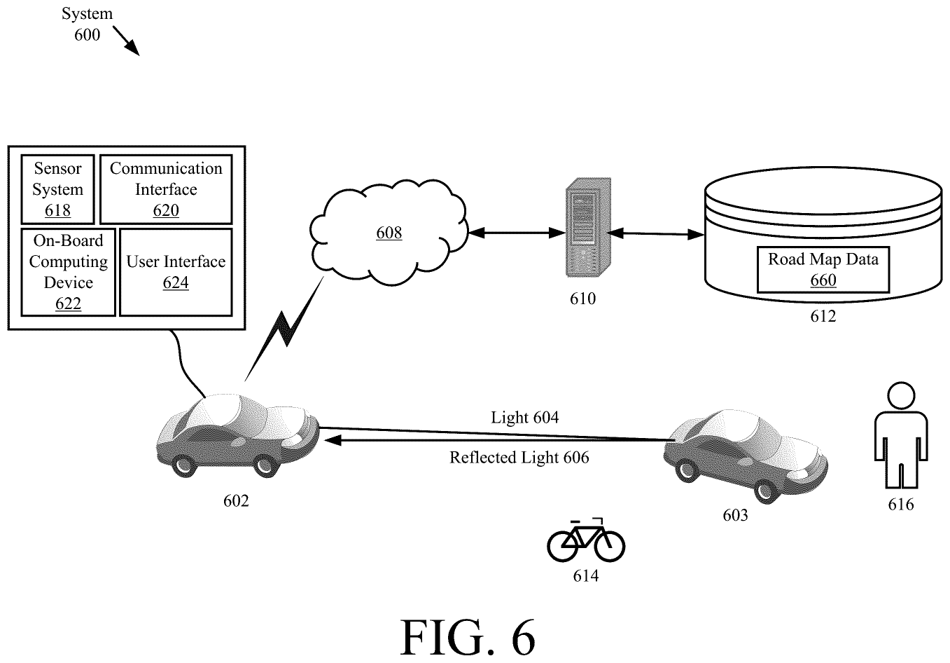

A vector tile may be loaded onto the client device 102 when a user 198 thereof performs a user software interaction to move or zoom the displayed grid 150. The client device 102 generates a tile request 112 in response to the user software interaction. The tile request 112 is communicated to the server 108. In turn, the server 108 converts the tile request into a spatial query 114 and uses the spatial query 114 to retrieve geometric data 116 from the datastore 110. The geometric data 116 is used by the server to generate vector tile(s) 118, which is(are) communicated to the client device for display via the web application 104 and/or for use in controlling operations of a robot 199. The robot 199 can include, but is not limited to, an AV and/or an articulating arm. The operations can include, but are not limited to, autonomous operations. For example, the vector tile(s) is(are) used to control autonomous driving operations of an AV and/or autonomous joint movements of an articulating arm. The manner in which autonomous driving operations of an AV can be controlled using a vector map and/or other type of map is discussed in detail below in relation to FIGS. 6-9.

Geographic information is encoded into each vector tile 152, 154 by converting geographic coordinates (e.g., longitude, latitude and/or elevation) into vector tile grid coordinates. The small piece of map can comprise geometries 162 including points, lines and polygons. The points, lines and polygons are referred to herein as vectors 166. Metadata 164 can be associated with each vector 166. The metadata can include, but is not limited to, vector tile layers, object attributes, and/or object relationships. The vector tile layers can include any known or to be known vector tile layers. The object attributes can include, but are not limited to, names and addresses. The vectors 166 and metadata 164 are stored in a datastore 110 as geometric data 160 and/or geometric artifacts 172. The geometric data 160 and geometric artifacts 172 can be the same as or substantially similar to each other. Thus, in some scenarios, both datastore entries are not provided.

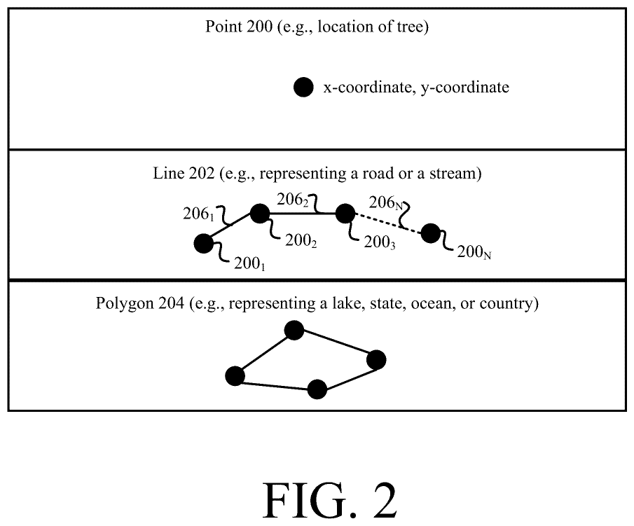

FIG. 2 shows an illustrative point 200, line 202 and polygon 204. The point 200 is defined by a single x coordinate and y coordinate. The point can represent, for example, a location of a tree. Line 202 is defined by a plurality of points 200₁, 200₂, 200₃, . . . , 200_{N} that are connected to each other via line segments 206₁, 206₂, . . . , 206_{N}. The line 202 may represent, for example, a road or a stream. Polygon 204 is defined by three or more points that are connected to each other by line segments so as to form a closed shape. The polygon 204 can represent, for example, a geographic object such as a lake, a state, an ocean or a country. The perimeter of the polygon 204 defines a boundary for the geographic object. The points, lines and polygons are encoded as x-y pairs relative to a top left corner 151 of the grid 150 in a right-down manner.

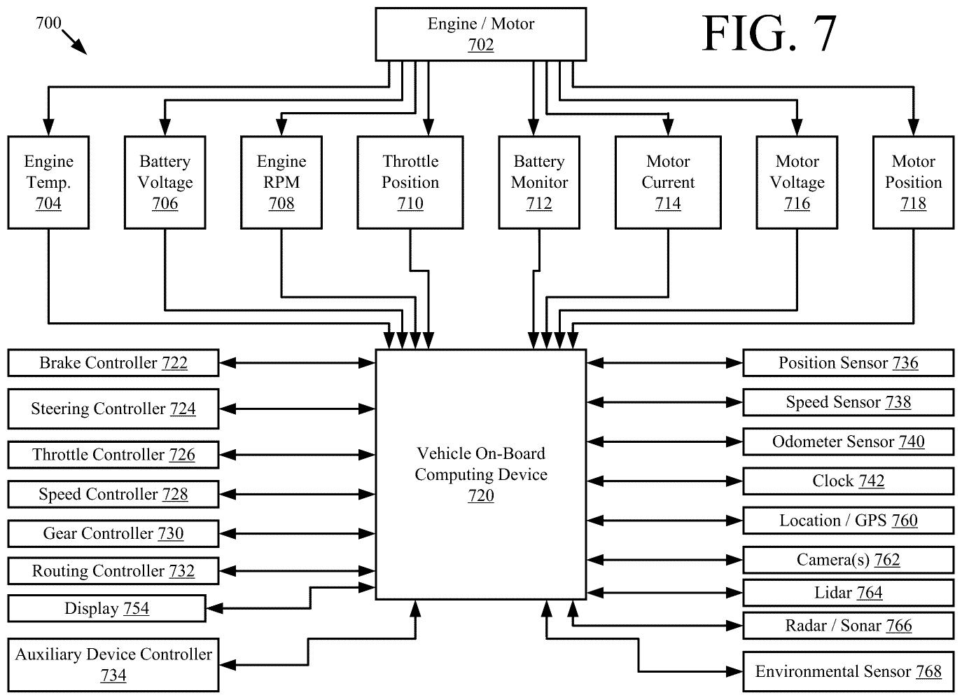

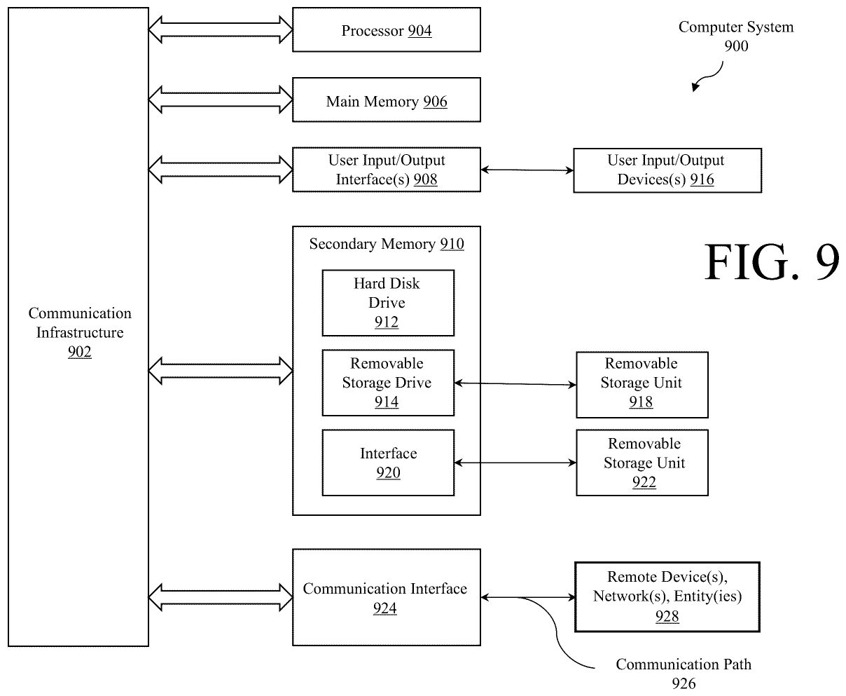

FIG. 3 provides a flow diagram of a method 300 for continuously generating map geometry artifacts (for example, geometry artifacts 172 of FIG. 1) in a standard format. Method 300 will be discussed below as being performed by a computing device. The present solution is not limited to this implementation. Method 300 can be performed by one or more processors, processing devices, computing devices and/or computing systems. For example, some or all of method 300 can be performed by server(s) 108 of FIG. 1, on-board computing device 622 of FIG. 6, server(s) 610 of FIG. 6, vehicle on-board computing device 720 of FIG. 7, computer system 900 of FIG. 9, processor 904 of FIG. 9, and/or remote device(s) 928 of FIG. 9.

Method 300 begins with 302 and continues with 304 where a map (for example, map 170 of FIG. 1) is updated in a proprietary format. Any known or to be known technique for updating a map can be used here without limitation. A timestamp (for example, a timestamp in block 174 of FIG. 1) is stored in a datastore (for example, datastore 110 of FIG. 1) upon completion of the map update.

In 308, the computing device receives a query for any data objects of the map that were changed within a particular time period. The computing device initiates a search session responsive to the query as shown by block 310. A start time (for example, a start time in block 174 of FIG. 1) is stored in the datastore for the search session.

The computing device then performs lookup operations in block 314 to obtain a last time (for example, a last time in block 174 of FIG. 1) that the map was updated. The computing device also performs operations in block 316 to identify data object(s) that was (were) changed during the last update of the map. This identification can be made by accessing modified data object information (for example, information 124 of FIG. 1) that is stored in the datastore. The modified data object information can include, but is not limited to, a queue or list of data object(s) that were modified during at least the last map update. Map data (for example, map data 126 of FIG. 1) is obtained by the computing device in 318 for the identified data object(s).

Geometry artifacts (for example, geometry artifacts 128 of FIG. 1) are created in 320 by converting the proprietary format of the obtained map data to a standard geospatial format. Each geometric artifact comprises 2D grid coordinates (for example, an x coordinate and a y coordinate) for a point (for example, point 200 of FIG. 2), a line (for example, line 202 of FIG. 2) or a polygon (for example, polygon 204 of FIG. 2). The geometry artifacts are stored in the datastore as geometry artifact data (for example, geometry artifacts 172) and/or geometric data (for example, geometric data 160 of FIG. 1). Next, the search session ends as shown by block 324. A timestamp is stored in the datastore (for example, in block 174 of FIG. 1) for the completion time of the search session.

Method 300 may then continue with optional operations of blocks 328-330. These operations comprise: using the geometry artifacts to generate vector tiles (for example, vector tiles 140 of FIG. 1) in a standard format; store the vector tiles in the datastore; render the vector tiles (for example, in a window of the web application 104 of FIG. 1); and/or use the vector tiles to control a robot (for example, robot 199 of FIG. 1). Subsequently, method 300 continues with 322 where it ends or other operations are performed (for example, return to 302). Method 300 may be periodically or iterative repeated (for example, every M minutes).

One advantage of method 300 is it provides a system (for example, system 100 of FIG. 1) with the ability to maintain an up-to-date representation of vector map geometry that can be consumed by different applications. Because the geometric artifacts are stored in a standard format and are up-to-date, they enable the system to perform real time visualization and/or spatial searches of the vector map.

FIG. 4 provides a flow diagram of a method 400 for editing vector tiles in a standard format based on changes to a map in a proprietary format. Vector tiles in a standard formal allow for compatibility and integration with different applications and online services. Method 400 will be discussed below as being performed by a computing device. The present solution is not limited to this implementation. Method 400 can be performed by one or more processors, processing devices, computing devices and/or computing systems. For example, some or all of method 400 can be performed by server(s) 108 of FIG. 1, on-board computing device 622 of FIG. 6, server(s) 610 of FIG. 6, vehicle on-board computing device 720 of FIG. 7, computer system 900 of FIG. 9, processor 904 of FIG. 9, and/or remote device(s) 928 of FIG. 9.

Method 400 begins with 402 and continues with 404 where the computing device receives a message that an entity of a map (for example, map 170 of FIG. 1) has changed. This message can be received from a map data source (for example, map data source 120 of FIG. 1). The map is stored in a proprietary format within a datastore (for example, datastore 110 of FIG. 1). In 406, the computing device identifies one or more vector tiles (for example, vector tiles 140 of FIG. 1) that is associated with the changed map entity. The vector tiles are in a standard vector tile format (for example, a 2D grid format). The identified vector tile(s) (for example, vector tiles 130 of FIG. 1) is(are) obtained by the computing device from the datastore in 408. The obtained vector tile(s) is(are) stored in a protocol buffer (for example, protocol buffer 132 of FIG. 1). In 412, the computing device decodes the vector tiles stored in the protocol buffer. This decoding can be achieved, for example, using a known mapbox/pdf JavaScript library for decoding/encoding protocol buffers and a known mapbox/vector-tile library for accessing layers/features of vector tiles.

In 414, the computing device generates geospatial data by converting a format of the decoded vector tile information into a geospatial format representing geographic features and their non-spatial attributes. The geospatial format can include, but is not limited to, a known GeoJSON representation. The geospatial data is processed in 416 to generate edited geospatial data. This processing can involve adding, removing and/or modifying geographic feature(s) and associated non-spatial attribute(s). The edited geospatial data is encoded in 418 to generate modified vector tile(s) (for example, encoded geometric information 134 of FIG. 1). The known Tippecanoe tool can be used to facilitate this encoding. The modified vector tile(s) is(are) in a standard vector tile format. This encoding can be achieved using, for example, a known Tippecanoe tool that generates mapbox vector tiles. The modified vector tile(s) is(are) stored in the datastore as shown by block 420 (for example, as updated versions of vector tiles 140 of FIG. 1).

Method 400 may then continue with optional operations of blocks 422-426. These operations can involve: receiving a request for a vector tile (for example, request 182 of FIG. 1) from a client device (for example, client device 180 of FIG. 1); obtaining the vector tile (for example, vector tile 140 of FIG. 1) from the datastore; and communicating the vector tile to the client device for rendering on a display and/or use in controlling a robot (for example, robot 199 of FIG. 1). Subsequently, method 400 continues with 428 where it ends or other operations are performed (for example, return to 402).

FIG. 5 provides a flow diagram of a method 500 for on-the-fly vector tile generation. Generating vector tiles at request time instead of in a batch job reduces complexity and cost while improving a user experience in relation to the maps. In this regard, it should be understood that a vector tile generation pipeline is responsible for creating vector tiles that can be rendered on front end hardware. The vector tile generation jobs typically run every hour. These jobs have the following drawbacks: time consuming (some cities take greater than 1.5 hours to complete); resource intensive since they require a relatively large amount of disk space; expensive since they create millions of files per job; and out of date due to vector tiles becoming out of sync with map server data. Using an on-the-fly solution for generating vector tiles solves these drawbacks.

Method 500 will be discussed below as being performed by a computing device. The present solution is not limited to this implementation. Method 500 can be performed by one or more processors, processing devices, computing devices and/or computing systems. For example, some or all of method 500 can be performed by server(s) 108 of FIG. 1, on-board computing device 622 of FIG. 6, server(s) 610 of FIG. 6, vehicle on-board computing device 720 of FIG. 7, computer system 900 of FIG. 9, processor 904 of FIG. 9, and/or remote device(s) 928 of FIG. 9.

Method 500 begins with 502 and continues with 504 where the computing device receives a request for a vector tile (for example, request 112 of FIG.) from a client device (for example, client device 102 of FIG. 1). The request is converted by the computing device in 506 into a spatial query for geometry data (for example, spatial query 114 of FIG. 1). The geometry data (for example, geometric data 160 and/or geometric artifacts 172 of FIG. 1) includes geometries (for example, geometries 162 of FIG. 1) having vectors (for example, vectors 166 of FIG. 1) with 2D grid coordinates located within and/or on a spatial boundary of the vector tile. This conversion can be achieved using a known PostGIS function or an SQL function.

The spatial query is used in 508 to retrieve geometry data (for example, geometric data 116 of FIG. 1) from a datastore (for example, datastore 110 of FIG. 1). The datastore may include, but is not limited to, a PostGres datastore. The geometry data is transformed into vector tile(s) (for example, vector tile(s) 118 of FIG. 1) with a standard vector tile format, as shown by 510. This transformation can be achieved using any known or to be known technique to convert data from a spatial format to a Mapbox vector tile (MVT) binary format. In 512, the vector tile is communicated from the computing device to a web application (for example, web application 104 of FIG. 1) the client device. The vector tile can optionally be displayed by the client device and/or used to control a robotic device (for example, robot 199 of FIG. 9), as shown by 514. In 516, method 500 ends or other operations are performed (for example, return to 502).

### Illustrative Vehicle Based Systems

The above described system 100 can be used in a plurality of applications. Such applications include, but are not limited to, vehicle based applications. The following discussion is provided to illustrate how the system 100 of the present solution can be used to facilitate control of a vehicle (e.g., for collision avoidance and/or autonomous driving purposes). The vehicle can include, but is not limited to, an autonomous vehicle.

FIG. 6 illustrates an example system 600, in accordance with aspects of the disclosure. System 600 comprises a vehicle 602 that is traveling along a road in a semi-autonomous or autonomous manner. Vehicle 602 is also referred to in this document as AV 602. AV 602 can include, but is not limited to, a land vehicle (as shown in FIG. 6), an aircraft, or a watercraft. As noted above, except where specifically noted this disclosure is not necessarily limited to AV embodiments, and it may include non-autonomous vehicles in some embodiments.

AV 602 is generally configured to detect objects in its proximity. The objects can include, but are not limited to, a vehicle 603, cyclist 614 (such as a rider of a bicycle, electric scooter, motorcycle, or the like) and/or a pedestrian 616.

As illustrated in FIG. 6, the AV 602 may include a sensor system 618, an on-board computing device 622, a communications interface 620, and a user interface 624. Autonomous vehicle system may further include certain components (as illustrated, for example, in FIG. 7) included in vehicles, which may be controlled by the on-board computing device 622 using a variety of communication signals and/or commands, such as, for example, acceleration signals or commands, deceleration signals or commands, steering signals or commands, braking signals or commands, etc.

The sensor system 618 may include one or more sensors that are coupled to and/or are included within the AV 602. For example, such sensors may include, without limitation, a lidar system, a radio detection and ranging (radar) system, a laser detection and ranging (LADAR) system, a sound navigation and ranging (sonar) system, one or more cameras (for example, visible spectrum cameras, infrared cameras, etc.), temperature sensors, position sensors (for example, a global positioning system (GPS), etc.), location sensors, fuel sensors, motion sensors (for example, an inertial measurement unit (IMU), etc.), humidity sensors, occupancy sensors, or the like. The sensor data can include information that describes the location of objects within the surrounding environment of the AV 602, information about the environment itself, information about the motion of the AV 602, information about a route of the vehicle, or the like. As AV 602 travels over a surface, at least some of the sensors may collect data pertaining to the surface.

The AV 602 may also communicate sensor data collected by the sensor system to a remote computing device 610 (for example, a cloud processing system) over communications network 608. Remote computing device 610 may be configured with one or more servers to perform one or more processes of the technology described in this document. Remote computing device 610 may also be configured to communicate data/instructions to/from AV 602 over network 608, to/from server(s) and/or datastore(s) 612. Datastore(s) 612 may include, but are not limited to, database(s).

Network 608 may include one or more wired or wireless networks. For example, the network 608 may include a cellular network (for example, a long-term evolution (LTE) network, a code division multiple access (CDMA) network, a 3G network, a 4G network, a 5G network, another type of next generation network, etc.). The network may also include a public land mobile network (PLMN), a local area network (LAN), a wide area network (WAN), a metropolitan area network (MAN), a telephone network (for example, the Public Switched Telephone Network (PSTN)), a private network, an ad hoc network, an intranet, the Internet, a fiber optic-based network, a cloud computing network, and/or the like, and/or a combination of these or other types of networks.

AV 602 may retrieve, receive, display, and edit information generated from a local application or delivered via network 608 from datastore 612. Datastore 612 may be configured to store and supply raw data, indexed data, structured data, road map data 660, program instructions or other configurations as is known.

The communications interface 620 may be configured to allow communication between AV 602 and external systems, such as, for example, external devices, sensors, other vehicles, servers, data stores, databases, etc. The communications interface 620 may utilize any now or hereafter known protocols, protection schemes, encodings, formats, packaging, etc. such as, without limitation, Wi-Fi, an infrared link, Bluetooth, etc. The user interface system 624 may be part of peripheral devices implemented within the AV 602 including, for example, a keyboard, a touch screen display device, a microphone, and a speaker, etc. The vehicle also may receive state information, descriptive information or other information about devices or objects in its environment via the communication interface 620 over communication links such as those known as vehicle-to-vehicle, vehicle-to-object or other V2X communication links. The term “V2X” refers to a communication between a vehicle and any object that the vehicle may encounter or affect in its environment.

FIG. 7 illustrates an example system architecture 700 for a vehicle, in accordance with aspects of the disclosure. Vehicles 602 and/or 603 of FIG. 6 can have the same or similar system architecture as that shown in FIG. 7. Thus, the following discussion of system architecture 700 is sufficient for understanding vehicle(s) 602, 603 of FIG. 6. However, other types of vehicles are considered within the scope of the technology described in this document and may contain more or less elements as described in association with FIG. 7. As a non-limiting example, an airborne vehicle may exclude brake or gear controllers, but may include an altitude sensor. In another non-limiting example, a water-based vehicle may include a depth sensor. One skilled in the art will appreciate that other propulsion systems, sensors and controllers may be included based on a type of vehicle, as is known.

As shown in FIG. 7, system architecture 700 for a vehicle includes an engine or motor 702 and various sensors 704-718 for measuring various parameters of the vehicle. In gas-powered or hybrid vehicles having a fuel-powered engine, the sensors may include, for example, an engine temperature sensor 704, a battery voltage sensor 706, an engine revolutions per minute (RPM) sensor 708, and a throttle position sensor 710. If the vehicle is an electric or hybrid vehicle, then the vehicle may have an electric motor, and accordingly includes sensors such as a battery monitoring system 712 (to measure current, voltage and/or temperature of the battery), motor current 714 and voltage 716 sensors, and motor position sensors 718 such as resolvers and encoders.

Operational parameter sensors that are common to both types of vehicles include, for example: a position sensor 736 such as an accelerometer, gyroscope and/or inertial measurement unit; a speed sensor 738; and an odometer sensor 740. The vehicle also may have a clock 742 that the system uses to determine vehicle time during operation. The clock 742 may be encoded into the vehicle on-board computing device, it may be a separate device, or multiple clocks may be available.

The vehicle also may include various sensors that operate to gather information about the environment in which the vehicle is traveling. These sensors may include, for example: a location sensor 760 (such as a Global Positioning System (GPS) device); object detection sensors such as one or more cameras 762; a lidar system 764; and/or a radar and/or a sonar system 766. The sensors also may include environmental sensors 768 such as a precipitation sensor and/or ambient temperature sensor. The object detection sensors may enable the vehicle to detect objects that are within a given distance range of the vehicle in any direction, while the environmental sensors collect data about environmental conditions within the vehicle's area of travel.

During operations, information is communicated from the sensors to a vehicle on-board computing device 720. The vehicle on-board computing device 720 may be implemented using the computer system of FIG. 9. The vehicle on-board computing device 720 analyzes the data captured by the sensors and optionally controls operations of the vehicle based on results of the analysis. For example, the vehicle on-board computing device 720 may control: braking via a brake controller 722; direction via a steering controller 724; speed and acceleration via a throttle controller 726 (in a gas-powered vehicle) or a motor speed controller 728 (such as a current level controller in an electric vehicle); a differential gear controller 730 (in vehicles with transmissions); and/or other controllers. Auxiliary device controller 734 may be configured to control one or more auxiliary devices, such as testing systems, auxiliary sensors, mobile devices transported by the vehicle, etc.

Geographic location information may be communicated from the location sensor 760 to the vehicle on-board computing device 720, which may then access a map of the environment that corresponds to the location information to determine known fixed features of the environment such as streets, buildings, stop signs and/or stop/go signals. Captured images from the cameras 762 and/or object detection information captured from sensors such as lidar system 764 is communicated from those sensors) to the vehicle on-board computing device 720. The object detection information and/or captured images are processed by the vehicle on-board computing device 720 to detect objects in proximity to the vehicle. Any known or to be known technique for making an object detection based on sensor data and/or captured images can be used in the embodiments disclosed in this document.

Lidar information is communicated from lidar system 764 to the vehicle on-board computing device 720. Additionally, captured images are communicated from the camera(s) 762 to the vehicle on-board computing device 720. The lidar information and/or captured images are processed by the vehicle on-board computing device 720 to detect objects in proximity to the vehicle. The manner in which the object detections are made by the vehicle on-board computing device 720 includes such capabilities detailed in this disclosure.

In addition, the system architecture 700 may include an onboard display device 754 that may generate and output an interface on which sensor data, vehicle status information, or outputs generated by the processes described in this document are displayed to an occupant of the vehicle. The display device may include, or a separate device may be, an audio speaker that presents such information in audio format.

The vehicle on-board computing device 720 may include and/or may be in communication with a routing controller 732 that generates a navigation route from a start position to a destination position for an autonomous vehicle. The routing controller 732 may access a map data store to identify possible routes and road segments that a vehicle can travel on to get from the start position to the destination position. The routing controller 732 may score the possible routes and identify a preferred route to reach the destination. For example, the routing controller 732 may generate a navigation route that minimizes Euclidean distance traveled or other cost function during the route, and may further access the traffic information and/or estimates that can affect an amount of time it will take to travel on a particular route. Depending on implementation, the routing controller 732 may generate one or more routes using various routing methods, such as Dijkstra's algorithm, Bellman-Ford algorithm, or other algorithms. The routing controller 732 may also use the traffic information to generate a navigation route that reflects expected conditions of the route (for example, current day of the week or current time of day, etc.), such that a route generated for travel during rush-hour may differ from a route generated for travel late at night. The routing controller 732 may also generate more than one navigation route to a destination and send more than one of these navigation routes to a user for selection by the user from among various possible routes.

In various embodiments, the vehicle on-board computing device 720 may determine perception information of the surrounding environment of the AV. Based on the sensor data provided by one or more sensors and location information that is obtained, the vehicle on-board computing device 720 may determine perception information of the surrounding environment of the AV. The perception information may represent what an ordinary driver would perceive in the surrounding environment of a vehicle. The perception data may include information relating to one or more objects in the environment of the AV. For example, the vehicle on-board computing device 720 may process sensor data (for example, lidar or radar data, camera images, etc.) in order to identify objects and/or features in the environment of AV. The objects may include traffic signals, roadway boundaries, other vehicles, pedestrians, and/or obstacles, etc. The vehicle on-board computing device 720 may use any now or hereafter known object recognition algorithms, video tracking algorithms, and computer vision algorithms (for example, track objects frame-to-frame iteratively over a number of time periods) to determine the perception.

In some embodiments, the vehicle on-board computing device 720 may also determine, for one or more identified objects in the environment, the current state of the object. The state information may include, without limitation, for each object: current location; current speed and/or acceleration, current heading; current pose; current shape, size, or footprint; type (for example: vehicle, pedestrian, bicycle, static object or obstacle); and/or other state information.

The vehicle on-board computing device 720 may perform one or more prediction and/or forecasting operations. For example, the vehicle on-board computing device 720 may predict future locations, trajectories, and/or actions of one or more objects. For example, the vehicle on-board computing device 720 may predict the future locations, trajectories, and/or actions of the objects based at least in part on perception information (for example, the state data for each object comprising an estimated shape and pose determined as discussed below), location information, sensor data, and/or any other data that describes the past and/or current state of the objects, the AV, the surrounding environment, and/or their relationship(s). For example, if an object is a vehicle and the current driving environment includes an intersection, the vehicle on-board computing device 720 may predict whether the object will likely move straight forward or make a turn. If the perception data indicates that the intersection has no traffic light, the vehicle on-board computing device 720 may also predict whether the vehicle may have to fully stop prior to entering the intersection.

In various embodiments, the vehicle on-board computing device 720 may determine a motion plan for the autonomous vehicle. For example, the vehicle on-board computing device 720 may determine a motion plan for the autonomous vehicle based on the perception data and/or the prediction data. Specifically, given predictions about the future locations of proximate objects and other perception data, the vehicle on-board computing device 720 can determine a motion plan for the AV that best navigates the autonomous vehicle relative to the objects at their future locations.

In some embodiments, the vehicle on-board computing device 720 may receive predictions and make a decision regarding how to handle objects and/or actors in the environment of the AV. For example, for a particular actor (for example, a vehicle with a given speed, direction, turning angle, etc.), the vehicle on-board computing device 720 decides whether to overtake, yield, stop, and/or pass based on, for example, traffic conditions, map data, state of the autonomous vehicle, etc. Furthermore, the vehicle on-board computing device 720 also plans a path for the AV to travel on a given route, as well as driving parameters (for example, distance, speed, and/or turning angle). That is, for a given object, the vehicle on-board computing device 720 decides what to do with the object and determines how to do it. For example, for a given object, the vehicle on-board computing device 720 may decide to pass the object and may determine whether to pass on the left side or right side of the object (including motion parameters such as speed). The vehicle on-board computing device 720 may also assess the risk of a collision between a detected object and the AV. If the risk exceeds an acceptable threshold, it may determine whether the collision can be avoided if the autonomous vehicle follows a defined vehicle trajectory and/or implements one or more dynamically generated emergency maneuvers is performed in a pre-defined time period (for example, N milliseconds). If the collision can be avoided, then the vehicle on-board computing device 720 may execute one or more control instructions to perform a cautious maneuver (for example, mildly slow down, accelerate, change lane, or swerve). In contrast, if the collision cannot be avoided, then the vehicle on-board computing device 720 may execute one or more control instructions for execution of an emergency maneuver (for example, brake and/or change direction of travel).

As discussed above, planning and control data regarding the movement of the autonomous vehicle is generated for execution. The vehicle on-board computing device 720 may, for example, control braking via a brake controller; direction via a steering controller; speed and acceleration via a throttle controller (in a gas-powered vehicle) or a motor speed controller (such as a current level controller in an electric vehicle); a differential gear controller (in vehicles with transmissions); and/or other controllers.

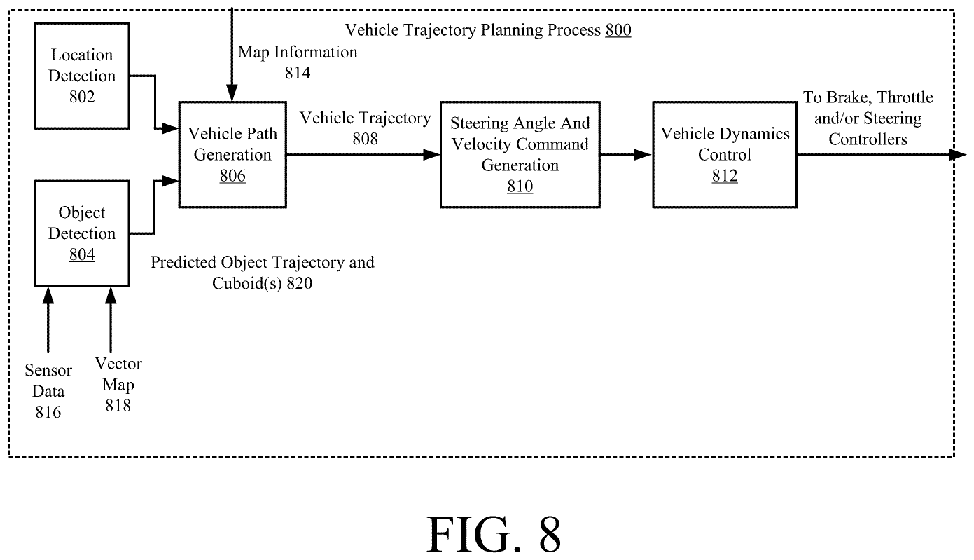

FIG. 8 provides a block diagram that is useful for understanding how motion or movement of an AV is achieved in accordance with the present solution. All of the operations performed in blocks 802-812 can be performed by the on-board computing device (for example, on-board computing device 622 of FIGS. 6 and/or 720 of FIG. 7) of a vehicle (for example, AV 602 of FIG. 6).

In block 802, a location of the AV (for example, AV 602 of FIG. 6) is detected. This detection can be made based on sensor data output from a location sensor (for example, location sensor 760 of FIG. 7) of the AV. This sensor data can include, but is not limited to, GPS data. The detected location of the AV is then passed to block 806.

In block 804, an object (for example, vehicle 603 of FIG. 6) is detected within proximity of the AV (for example, <100+ meters). This detection is made based on sensor data output from a camera (for example, camera 762 of FIG. 7) of the AV and/or a lidar system (for example, lidar system 764 of FIG. 7) of the AV. For example, image processing is performed to detect an instance of an object of a certain class (for example, a vehicle, cyclist or pedestrian) in an image. The image processing/object detection can be achieved in accordance with any known or to be known image processing/object detection algorithm.

Additionally, a predicted trajectory is determined in block 804 for the object. The object's trajectory is predicted in block 804 based on the object's class, cuboid geometry(ies), cuboid heading(s) and/or contents of a map 818 (for example, sidewalk locations, lane locations, lane directions of travel, driving rules, etc.). The manner in which the cuboid geometry(ies) and heading(s) are determined will become evident as the discussion progresses. At this time, it should be noted that the cuboid geometry(ies) and/or heading(s) are determined using sensor data of various types (for example, 2D images, 3D lidar point clouds) and a map 818 (for example, lane geometries). Techniques for predicting object trajectories based on cuboid geometries and headings may include, for example, predicting that the object is moving on a linear path in the same direction as the heading direction of a cuboid. The predicted object trajectories can include, but are not limited to, the following trajectories: a trajectory defined by the object's actual speed (for example, 1 mile per hour) and actual direction of travel (for example, west); a trajectory defined by the object's actual speed (for example, 1 mile per hour) and another possible direction of travel (for example, south, south-west, or X (for example, 40°) degrees from the object's actual direction of travel in a direction towards the AV) for the object; a trajectory defined by another possible speed for the object (for example, 2-10 miles per hour) and the object's actual direction of travel (for example, west); and/or a trajectory defined by another possible speed for the object (for example, 2-10 miles per hour) and another possible direction of travel (for example, south, south-west, or X (for example, 40°) degrees from the object's actual direction of travel in a direction towards the AV) for the object. The possible speed(s) and/or possible direction(s) of travel may be pre-defined for objects in the same class and/or sub-class as the object. It should be noted once again that the cuboid defines a full extent of the object and a heading of the object. The heading defines a direction in which the object's front is pointed, and therefore provides an indication as to the actual and/or possible direction of travel for the object.

Information 820 specifying the object's predicted trajectory, the cuboid geometry(ies)/heading(s) is provided to block 806. In some scenarios, a classification of the object is also passed to block 806. In block 806, a vehicle trajectory is generated using the information from blocks 802 and 804. Techniques for determining a vehicle trajectory using cuboids may include, for example, determining a trajectory for the AV that would pass the object when the object is in front of the AV, the cuboid has a heading direction that is aligned with the direction in which the AV is moving, and the cuboid has a length that is greater than a threshold value. The present solution is not limited to the particulars of this scenario. The vehicle trajectory 808 can be determined based on the location information from block 802, the object detection information from block 804, and/or map information 814 (which is pre-stored in a data store of the vehicle). The map information 814 may include, but is not limited to, all or a portion of road map(s) 660 of FIG. 6. The vehicle trajectory 808 may represent a smooth path that does not have abrupt changes that would otherwise provide passenger discomfort. For example, the vehicle trajectory is defined by a path of travel along a given lane of a road in which the object is not predicted to travel within a given amount of time. The vehicle trajectory 808 is then provided to block 810.

In block 810, a steering angle and velocity command is generated based on the vehicle trajectory 808. The steering angle and velocity command are provided to block 810 for vehicle dynamics control, i.e., the steering angle and velocity command causes the AV to follow the vehicle trajectory 808.

Various embodiments can be implemented, for example, using one or more computer systems, such as computer system 900 shown in FIG. 9. Computer system 900 can be any computer capable of performing the functions described in this document.

Computer system 900 includes one or more processors (also called central processing units, or CPUs), such as a processor 904. Processor 904 is connected to a communication infrastructure or bus 902. Optionally, one or more of the processors 904 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 also includes user input/output device(s) 916, such as monitors, keyboards, pointing devices, etc., that communicate with communication infrastructure 902 through user input/output interface(s) 908.

Computer system 900 also includes a main or primary memory 906, such as random access memory (RAM). Main memory 906 may include one or more levels of cache. Main memory 906 has stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be an external hard drive, a universal serial bus (USB) drive, a memory card such as a compact flash card or secure digital memory, a floppy disk drive, a magnetic tape drive, a compact disc drive, an optical storage device, a tape backup device, and/or any other storage device/drive.

Removable storage drive 914 may interact with a removable storage unit 918. Removable storage unit 918 includes a computer usable or readable storage device having stored thereon computer software (control logic) and/or data. Removable storage unit 918 may be an external hard drive, a universal serial bus (USB) drive, a memory card such as a compact flash card or secure digital memory, a floppy disk, a magnetic tape, a compact disc, a DVD, an optical storage disk, and/any other computer data storage device. Removable storage drive 914 reads from and/or writes to removable storage unit 918 in a well-known manner.

According to an example embodiment, secondary memory 910 may include other means, instrumentalities or other approaches for allowing computer programs and/or other instructions and/or data to be accessed by computer system 900. Such means, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 enables computer system 900 to communicate and interact with any combination of remote devices, remote networks, remote entities, etc. (individually and collectively referenced by reference number 928). For example, communication interface 924 may allow computer system 900 to communicate with remote devices 928 over communications path 926, which may be wired and/or wireless, and which may include any combination of LANs, WANs, the Internet, etc. Control logic and/or data may be transmitted to and from computer system 900 via communication path 926.

In some embodiments, a tangible, non-transitory apparatus or article of manufacture comprising a tangible, non-transitory computer useable or readable medium having control logic (software) stored thereon is also referred to in this document as a computer program product or program storage device. This includes, but is not limited to, computer system 900, main memory 906, secondary memory 910, and removable storage units 918 and 922, as well as tangible articles of manufacture embodying any combination of the foregoing. Such control logic, when executed by one or more data processing devices (such as computer system 900), causes such data processing devices to operate as described in this document.

Based on the teachings contained in this disclosure, it will be apparent to persons skilled in the relevant art(s) how to make and use embodiments of this disclosure using data processing devices, computer systems and/or computer architectures other than that shown in FIG. 13. In particular, embodiments can operate with software, hardware, and/or operating system implementations other than those described in this document. ss

Terms that are relevant to this disclosure include:

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices. A computer program product is a memory device with programming instructions stored on it.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices which may be components of a single device or components of separate devices, together or collectively perform a process.

The term “object,” when referring to an object that is detected by a vehicle perception system or simulated by a simulation system, is intended to encompass both stationary objects and moving (or potentially moving) actors, except where specifically stated otherwise by use of the term “actor” or “stationary object.”

When used in the context of autonomous vehicle motion planning, the term “trajectory” refers to the plan that the vehicle's motion planning system will generate, and which the vehicle's motion control system will follow when controlling the vehicle's motion. A trajectory includes the vehicle's planned position and orientation at multiple points in time over a time horizon, as well as the vehicle's planned steering wheel angle and angle rate over the same time horizon. An autonomous vehicle's motion control system will consume the trajectory and send commands to the vehicle's steering controller, brake controller, throttle controller and/or other motion control subsystem to move the vehicle along a planned path.

A “trajectory” of an actor that a vehicle's perception or prediction systems may generate refers to the predicted path that the actor will follow over a time horizon, along with the predicted speed of the actor and/or position of the actor along the path at various points along the time horizon.

In this document, the terms “street,” “lane,” “road” and “intersection” are illustrated by way of example with vehicles traveling on one or more roads. However, the embodiments are intended to include lanes and intersections in other locations, such as parking areas. In addition, for autonomous vehicles that are designed to be used indoors (such as automated picking devices in warehouses), a street may be a corridor of the warehouse and a lane may be a portion of the corridor. If the autonomous vehicle is a drone or other aircraft, the term “street” or “road” may represent an airway and a lane may be a portion of the airway. If the autonomous vehicle is a watercraft, then the term “street” or “road” may represent a waterway and a lane may be a portion of the waterway.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes example embodiments for example fields and applications, it should be understood that the disclosure is not limited to the disclosed examples. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described in this document. Further, embodiments (whether or not explicitly described) have significant utility to fields and applications beyond the examples described in this document.

Embodiments have been described in this document with the aid of functional building blocks illustrating the implementation of specified functions and relationships. The boundaries of these functional building blocks have been arbitrarily defined in this document for the convenience of the description. Alternate boundaries can be defined as long as the specified functions and relationships (or their equivalents) are appropriately performed. Also, alternative embodiments can perform functional blocks, steps, operations, methods, etc. using orderings different than those described in this document.

The features from different embodiments disclosed herein may be freely combined. For example, one or more features from a method embodiment may be combined with any of the system or product embodiments. Similarly, features from a system or product embodiment may be combined with any of the method embodiments herein disclosed.

References in this document to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described in this document. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The features from different embodiments disclosed herein may be freely combined. For example, one or more features from a method embodiment may be combined with any of the system or product embodiments. Similarly, features from a system or product embodiment may be combined with any of the method embodiments herein disclosed.

The breadth and scope of this disclosure should not be limited by any of the above-described example embodiments but should be defined only in accordance with the following claims and their equivalents.

As described above, this document discloses system, method, and computer program product embodiments for operating a lidar system. The system embodiments include a processor or computing device implementing the methods for operating a lidar. The computer program embodiments include programming instructions, for example, stored in a memory, to cause a processor to perform the data management methods described in this document. The system embodiments also include a processor which is configured to perform the methods described in this document, for example, via the programming instructions. More generally, the system embodiments include a system comprising means to perform the steps of any of the methods described in this document.

1. A method for providing an electronic map, comprising:
identifying, by a computing device, at least one first data object that was changed during a last update of the electronic map in a first data format;
creating, by the computing device, at least one geometry artifact by converting a format of the at least one first data object from the first data format to a different second data format, the at least one geometry artifact comprising 2D grid coordinates for a point, a line or a polygon;
receiving, by the computing device, a request for a vector tile from a software application or online service, wherein the vector tile represents a portion of the electronic map;
converting, by the computing device, the request into a spatial query;
using, by the computing device, the spatial query to obtain the at least one geometry artifact;
using, by the computing device, the at least one geometry artifact to generate at least one first vector tile on-the-fly in the different second data format; and
selectively providing, by the computing device, the updated electronic map in the first data format or the at least one first vector tile in the second data format based on characteristics of the software application or online service requesting access to contents of the electronic map.

2. The method according to claim 1, wherein the first data format comprises a proprietary format and the different second data format comprises a standard geospatial format.

3. The method according to claim 1, further comprising storing the at least one first vector tile or the at least one first vector tile in a datastore accessible to the computing device.

4. The method according to claim 1, further comprising:
receiving, by the computing device, a request for any data objects of the electronic map that were changed within a particular period of time;
initiating a search session in response to reception of the request;
storing a start time of the search session; and
obtaining a last time that the electronic map was updated;
wherein the last time that the electronic map was updated is used to identify the at least one first data object.

5. The method according to claim 4, further comprising completing the search session after the at least one geometry artifact is stored in a datastore.

6. (canceled)

7. The method according to claim 1, wherein the at least one first vector tile comprises part of a web-based map.

8. The method according to claim 1, further comprising:
identifying at least one second vector tile from a plurality of vector tiles that is associated with at least one second data object of the electronic map which was changed;
decoding the at least one second vector tile;
generating first geospatial data by converting a format of the decoded at least one second vector tile into a geospatial format;
generating second geospatial data by adding, removing or modifying a geographic feature of the first geospatial data; and
encoding the second geospatial data to generate a modified vector tile.

9. The method according to claim 8, further comprising:
receiving, by the computing device, a request for a vector tile from the software application or online service; and
providing the modified vector tile to the software application or online service in response to the request for a vector tile.

10. The method according to claim 1, further comprising using the at least one vector tile to control operations of a robot.

11. A system, comprising:
a processor; and
a non-transitory computer-readable storage medium comprising programming instructions that are configured to cause the processor to implement a method for operating a system, wherein the programming instructions comprise instructions to:
identify at least one first data object that was changed during a last update of the electronic map in a first data format;
create at least one geometry artifact by converting a format of the at least one first data object from the first data format to a different second data format, the at least one geometry artifact comprising 2D grid coordinates for a point, a line or a polygon;
receiving a request for a vector tile from the software application or online service, wherein the vector tile represents a portion of the electronic map;
converting the request into a spatial query;
using the spatial query to obtain the at least one geometric artifact;
use the at least one geometry artifact to generate at least one first vector tile on-the-fly in the different second data format; and
selectively provide the updated electronic map in the first data format or the at least one first vector tile in the second data format based on characteristics of the software application or online service requesting access to contents of the electronic map.

12. The system according to claim 11, wherein the first data format comprises a proprietary format and the different second data format comprises a standard geospatial format.

13. The system according to claim 11, wherein the programming instructions further comprise instructions to store the at least one first vector tile or the at least one first vector tile in a datastore accessible to the computing device.

14. The system according to claim 11, wherein the programming instructions further comprise instructions to:
receive a request for any data objects of the electronic map that were changed within a particular period of time;
initiate a search session in response to reception of the request;
store a start time of the search session; and
obtain a last time that the electronic map was updated;
wherein the last time that the electronic map was updated is used to identify the at least one first data object.

15. The system according to claim 14, wherein the programming instructions further comprise instructions to complete the search session after the at least one geometry artifact is stored in a datastore.

16. (canceled)

17. The system according to claim 11, wherein the at least one first vector tile comprises part of a web-based map.

18. The system according to claim 11, wherein the programming instructions further comprise instructions to:
identify at least one second vector tile from a plurality of vector tiles that is associated with at least one second data object of the electronic map which was changed;
decode the at least one second vector tile;
generate first geospatial data by converting a format of the decoded at least one second vector tile into a geospatial format;
generate second geospatial data by adding, removing or modifying a geographic feature of the first geospatial data; and
encode the second geospatial data to generate a modified vector tile.

19. The system according to claim 18, wherein the programming instructions further comprise instructions to:
receive, a request for a vector tile from the software application or online service; and
provide the modified vector tile to the software application or online service in response to the request for a vector tile.

20. A non-transitory computer-readable medium that stores instructions that, when executed by at least one computing device, will cause the at least one computing device to perform operations comprising:
identifying at least one first data object that was changed during a last update of the electronic map in a first data format;
creating at least one geometry artifact by converting a format of the at least one first data object from the first data format to a different second data format, the at least one geometry artifact comprising 2D grid coordinates for a point, a line or a polygon;
receiving a request for a vector tile from a software application or online service, wherein the vector tile represents a portion of the electronic map;
converting the request into a spatial query;
using the spatial query to obtain the at least one geometric artifact;
using the at least one geometry artifact to generate at least one first vector tile on-the-fly in the different second data format; and
selectively providing the updated electronic map in the first data format or the at least one first vector tile in the second data format based on characteristics of the software application or online service requesting access to contents of the electronic map.
